(19) United States
(12) Patent Application Publication
(10) Pub. No.: US 2011/0295560 A1
(43) Pub. Date: Dec. 1, 2011

(54) CRITICALITY OF DATA

(75) Inventor: Christopher Crockford, Colchester (GB)

(73) Assignee: TRYSOME LIMITED, Surrey (GB)

(21) Appl. No.: 13/132,739

(22) PCT Filed: Dec. 2, 2009
(86) PCT No.: PCT/EP2009/066226

§ 371 Date: Aug. 17, 2011

(30) Foreign Application Priority Data
Dec. 3, 2008 (GB) 0822104.6

(51) Int. Cl. G06F 17/40

(52) U.S. Cl. 702/187

(57) ABSTRACT

One use of datalogger's is for gathering physiological conditional data about a person. A person can carry a datalogger and any associated sensors whilst they are in motion. The data recorded by the datalogger can then be uploaded to a third party system for analysis. Datalogger's that record physiological information have a variety of uses. For example, they can be used for medical purposes to monitor a patient's response to a course of treatment, or to monitor background factors about a person's lifestyle that may allow a doctor to advise on healthy living, and for sports purposes, to monitor an athlete's performance.

Energy consumption is a significant issue in the design of datalogger's. It is desirable for a datalogger to be small and light, with a self-contained energy source such as a battery, but also to operate for as long as possible. This document describes means to prolong the life of the battery attached to both sensory devices and datalogger's alike. Also detailed are scalable bandwidth mechanisms to present the time series data in a manner such that the system may maintain a level of control, which may be predetermined and controlled by the system administrator, of brief or verbose data transfer dependant upon the functionality required. A level of sensory device category criticality is also included in to the system such that graceful degradation of the system might be achieved whilst supporting a level of criticality of the data prescribed by the system designer.

This invention relates to data logging.

Dataloggers are devices that record sensed data and allow the data to be processed on the logging device, or uploaded to another device for secondary analysis. The data could be collected from sensors on the datalogger or from external sensors that communicate with the datalogger through wired or wireless protocols.

One use of dataloggers is for gathering physiological conditional data about a person. A person can carry a datalogger and any associated sensors whilst they are in motion. The data recorded by the datalogger can then be uploaded to a third party system for analysis. Dataloggers that record physiological information have a variety of uses. For example, they can be used for medical purposes to monitor a patient's response to a course of treatment, or to monitor background factors about a person's lifestyle that may allow a doctor to advise on healthy living (see U.S. Pat. No. 5,778,882, for instance); and for sports purposes, to monitor an athlete's performance.

Energy consumption is a significant issue in the design of dataloggers. It is desirable for a datalogger to be small and light, with a self-contained energy source such as a battery, but also to operate for as long as possible.

The data that is collected by dataloggers may be collected at discrete times or continuously. The period between data sampling may be application specific. An example of data that may be logged at discrete times is a patient's weight, which may be taken once a day, or more frequently if required. Data that varies more rapidly could be collected continuously. Examples include heart rate (or ECG curve), blood pressure, and SpO₂. Whilst these are referred to as being collected continuously, they may in fact be sampled at discrete times: typically several times per second in the case of an ECG curve.

Collecting data continuously generates large amounts of data. If the sensor in question communicates wirelessly with the datalogger then significant amounts of energy can be required to transmit the data from the sensor to the datalogger. This, together with the amount of memory needed to store the data, limits the amount of time for which the devices can gather continuous data such as ECG curves.

Current devices of this type are limited to gathering short bursts of ECG data. It would be desirable to be able to collect an increased amount of ECG (or other) data without increasing the size of the device. One motivation for this is to increase the amount of data available to clinicians for diagnostic purposes. Another motivation is to increase the integrity of the data to the level that is needed for monitoring drugs trials and the like.

Two routes are available for uploading the logged data. Some devices upload the logged data when they are physically attached to a docking station. The docking station has a communications facility. (Ethernet connection, modem port, or another form of network connection) by means of which it can pass the data to a remote computer. Other devices, which can be integrated into mobile phone systems as attached devices, may use mobile phone networks to upload the data. Uploading data wirelessly in this way has the advantage that the data can be uploaded when the user of the datalogger is away from his home, but has the disadvantage that it can use large amounts of energy.

Where a user is able to cope with complex functions, it may be desirable for a medical datalogger to offer those functions. However, medical dataloggers are likely to be used by people who, for reasons of infirmity, might be unable to operate a complex user interface or pay full attention to the data that is available from a datalogger. It is therefore desirable to simplify as much as possible the way in which the device can be used, and to allow other individuals to assist the user in benefitting from the data that is logged: either by analysing it on the user's behalf, or by providing assistance to the user if the data indicate that that is appropriate.

There is a need for a datalogger that is improved in one or more of the areas identified above; and an associated system for gathering, processing and distributing data from the datalogger.

According to one aspect of the present invention there is provided a means to upload the data from a plurality of sensory devices, in a structured and ordered manner, whilst allowing for dynamic data exchange between the plurality of sensory devices and a datalogger which sits in the middle of the sensory devices marshalling the data through the device and onto a centralised server.

By applying a profiled form of control to the data logger from the server, the data logger is not only afforded a certain level of autonomy with regards the control, processing and monitoring of the data from the sensory devices, as well as the control of the uploading of the acquired data to the server.

Dynamic control of the available bandwidths of the enabled wired and wireless communications interfaces, allows for best effort gradual managed degradation services to be established, even though the plurality of sensory devices and the datalogger may be in permanent motion.

The present invention will now be described by way of example, with reference to the accompanying drawings, in which:

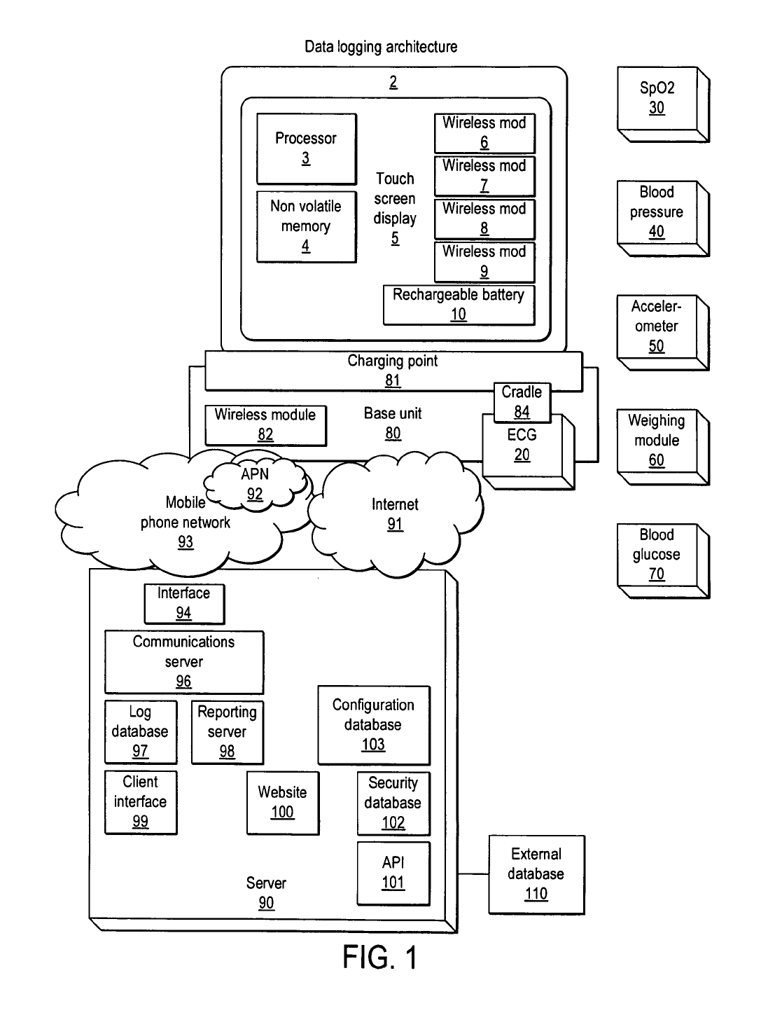

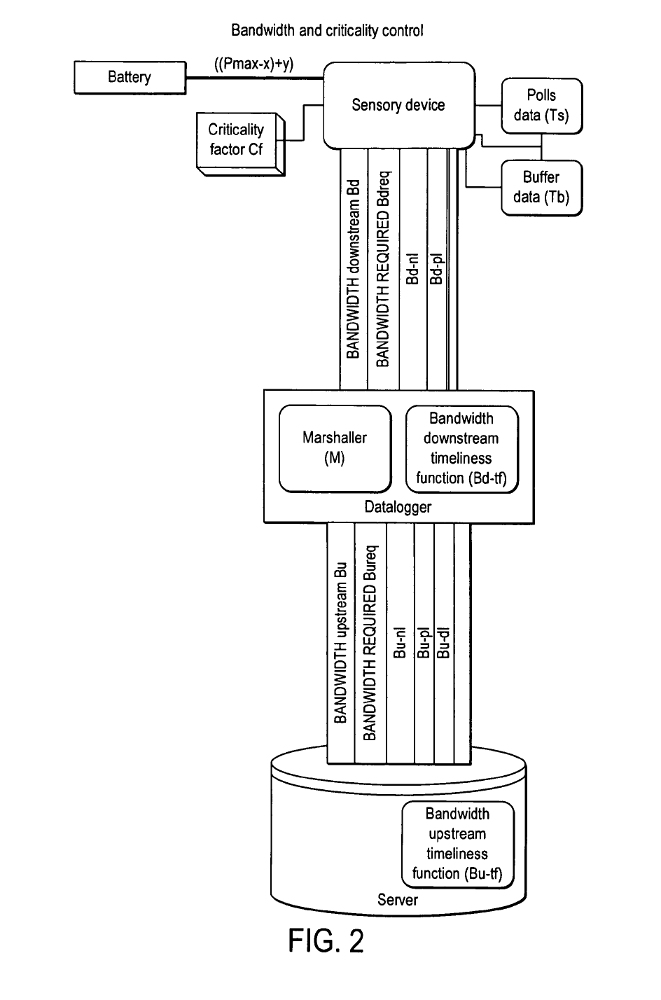

FIG. 1 is a schematic drawing of a datalogger and associated data collection, storage and analysis equipment. FIG. 2 is a schematic drawing of the adaptive and dynamic device criticality and bandwidth control mechanisms.

FIG. 1 shows a datalogger 1. The datalogger is a portable device having a housing 2 which encloses the other components. The datalogger comprises a processor 3, a non-volatile memory 4, a touch-screen display 5, a set of wireless interface modules 6, 7, 8, 9 and a rechargeable battery 10 which powers the other components. The processor runs program code that is stored as firmware 11 in memory 4. That code defines the functioning of the processor, and hence of the device. The display 5 is controlled by the processor to display images under the control of the program code. When a user touches the display, the display signals that pressure to the processor, which can use it as input. Instead of a touchscreen display, the device could have a simpler means of providing a user interface: for example a separate display and keypad, or a series of individual signalling LEDs (light emitting diodes).

Each wireless interface module operates for a respective wireless protocol, and is coupled to the processor for passing to the processor data received over a wireless channel and for receiving from the processor data to be transmitted over the wireless channel. In this example, modules 6 and 7 operate for short-range wireless protocols that can be used for communicating with sensors, and modules 8 and 9 operate for longer-range protocols that can be used for communicating with a data server. The same protocol could be used for both purposes. The device could alternatively be connected by a wired link for either purpose.

Conveniently each wireless module handles the lower layers, e.g. up to and including the session layer, for communication using its protocol. Examples of protocols suitable for communication with sensors include ANT, Bluetooth, IRDA, Zigbee, Wibree, UWB, and 802.11A/B/G/N, as well as proprietary means of data communications using ISM or registered frequency band communications, including the usage of such multiplexing algorithms as GSFK, OFDM, FHSS, DSSS, CSDM etc. Examples of protocols suitable for uplink communication include wireless LAN protocols such as 802.11 A/B/G/N and protocols suitable for carrying data over a mobile phone network such as such as GSM, GPRS, UMTS (3G) EDGE, and BGAN.

A series of sensor modules are available for operation with the datalogger 1. The sensors illustrated in FIG. 1 are as follows: ECG sensor module 20, SpO₂ sensor module 30, blood pressure sensor module 40, accelerometer module 50, weighing module 60, blood glucose sensor module 70. Sensor modules 20, 30, 40 and 50 are capable of continuous operation with the datalogger. These modules are preferably wearable or attachable to the user's body. For example, they could be embedded in or attached to belts, cuffs, implants or adhesive pads. Sensor modules 60 and 70 are capable of periodic operation with the data logger.

The datalogger itself, and potentially some of the sensors, are fully portable, in so far as they may be readily carried by a person.

The sensors provide data to the data logger through their own proprietary means, or choice in established protocol, presenting their respective data to the datalogger through an established or proprietary data format. The majority of wireless sensors, that are independent of mains power supply have performance limitations that are governed through an established balance between on board memory capacity, battery life, and sampling frequency.

A base unit 80 (see FIG. 1) operates with the datalogger and the sensor modules. The base unit is connected to the mains electrical supply via a suitable power conversion and limiting device and has a cradle 84 in which are terminals that provide a low-voltage output. This can be used to charge the rechargeable batteries of the datalogger and potentially some of the sensor modules, when they are in contact with it. Conveniently, the datalogger and the sensor modules have common charging connectors so that they can attach to the same charging point 81, or similar charging points, on the base unit. Alternatively, they could be charged by an inductive charging arrangement on the base unit, or via an electromagnetic near field behaviour concept potentially based on coupled resonance, such as Resonant Inductive Coupling. The base unit also has a wireless interface module 82 which operates according to a protocol that can communicate with the datalogger for uploading logged data from the datalogger. Examples of suitable protocols include wireless LAN protocols (e.g. 802.11A/B/G/N), Bluetooth and UWB. The base unit 80 also has a mechanism by which it can connect to a wider network such as the internet in order to pass the logged data to a remote server. For that purpose, the base unit may have a wired network connection (e.g. an Ethernet connection) 83.

A server infrastructure shown generally at 90 is capable of storing and processing data that has been logged by the datalogger. The server infrastructure may receive data from the datalogger over a publicly accessible network such as the internet 91, or over a private network such as a mobile phone network 93. The private network may be connected to the server infrastructure by an APN connection 92. An interface 94 interfaces between a communication server 96 and the connections 92, 95 by which data can be received from the datalogger. The communication server 96 manages communications with the datalogger 1. When data is to be uploaded from the datalogger, either the communication server may request that data or the data may be pushed by the datalogger. When the data is received by the communication server it formats the data as appropriate, and stores the data in a log database 97. That data may then be accessed by a reporting server 98, which can run automated reporting and analysis processes on the data, and by a client interface 99 by means of which the data can be accessed by users of the system, such as doctors. Information extracted via the client interface 99 can be presented via any suitable interface, for example a website 100, or via an API 101 to an external database 110. Credentials for authenticating users of the client interface are stored in a security database 102.

A configuration database 103 stores data defining the configuration of each datalogger that is used with the system. The configuration may include the firmware version installed on the datalogger, the type and identity of each sensor module that is paired with the datalogger and the firmware version installed on each sensor. The communication server can use that configuration information to control the datalogger, as will be described in more detail below.

The principal functions of the system are: (a) collection of data, (b) transfer of data from sensor to datalogger, (c) datalogger upload of data, (d) analysis or review of data and (e) configuration of the datalogger.

### Collection of Data

When data is to be collected, the user of the datalogger can carry the datalogger on his person, for example in a pocket, attached to his belt or attached to an armband. The user may do this 24 hours a day, or just during times when they require to collect data. The sensors that are to be used are deployed as required for taking measurements:

Wireless sensors may utilise either an established wireless data communication protocol, or a proprietary wireless or cabled means for communicating with the datalogger. When a communications path is present the sensory device may opt to route the data to its end point. When a communications path is not available the sensory device may seek to store the data locally upon its inbuilt memory, optionally using a cyclic purge system, such that only the latest data is kept in memory.

In one embodiment the sensory module may store a threshold power level that is accessible to its wireless module. If the wireless module can communicate with the datalogger using less than the pre-stored threshold transmit power level, then the sensing module promptly transmits the sampled data to the datalogger by means of the wireless module. If the wireless module of the sensing module cannot communicate with the datalogger at below the threshold transmit power level then the sensing module caches the sensed data in its local memory. When communication with the datalogger at below the threshold transmit power level is re-established, then the data from the memory is sent to the datalogger and then cyclically deleted from the memory. This allows significant power savings at both the sensor module and the datalogger since data can be kept at the sensor module until they can be transmitted to the datalogger with sufficiently low power.

Power usage by the sensor devices may also be managed by the datalogger. The datalogger may use the criticality factor of the device to determine a round robin polling order of the devices. Instead of each sensor device being allocated a communication slot in turn, devices that have a higher criticality factor could have relatively more slots allocated to them. Should the criticality factor of a sensor device warrant constant monitoring of said device, then the datalogger can maintain continuous communications with that highest criticality factor device until a threshold (e.g. a time-out) is met such that the remaining attached device's data must be uploaded. At this point the collecting device will ensure that the highest criticality factor device keeps its data in memory whilst the round robin polling scheme is applied to the lesser criticality factored devices.

In order to allow the datalogger to make use of data that is received in either an untimely manner or an out of sequence manner, the sensed data should be stored in such a manner that the time at which the data was acquired by the sensory device can be established by the datalogger. To achieve this, the sensory device may maintain a local clock with which to timestamp the data. Subsequently the sample value and the time value are sent, for example as a tuple pair, to the datalogger. In such a manner, the datalogger can determine the time at which each sample was taken. In some cases it may be possible for the datalogger to maintain a synchronous heartbeat with the sensory devices, which may establish the offset between the datalogger's internal clock and the internal clocks of the sensory devices attached to it. Thus, the sensory device can send sensed data to the datalogger continuously, as it is sensed, or in bursts having been cached for some time at the sensor.

For sensors that utilise wireless communications, be it infra red, radio frequency, electromagnetic near field or other means, power is a key issue, bearing in mind that if the sensor is to store energy it would most conveniently have to be battery powered. The levels of transmit power available to the sensory devices may also be controlled by legislation that differs from region to region. If it is assumed that a sensory device starts by utilising the maximum transmitted power available (Pmax) to the transmitter, taking into account any gain by antennas or loss through wiring, such that the EIRP (equivalent isotropically radiated power) is within the legal limit, then if communications between the sensory device and the datalogger can be established then the sensory units' data may be uploaded in near real time, utilising the time stamped principle to ensure ordered data delivery. If the transmit power of the sensory device can be scaled down to a lower power (Pmax−x), such that the maximum permitted EIRP for that region is not exceeded at any point, then if it is to conserve battery life the sensory unit should scale down the transmit power. If communications between the data logger and the sensory device are lost or become weak, then the sensory device can store the data to local memory. The sensory device can subsequently re-establish communications using, if necessary, the maximum amount of power available to the sensory device (Pmax).

If the datalogger and sensory devices are configured to be able to send an acknowledgement of the time stamped data that has been sent and received, as would be the case in TCP communications. The sensory device should be able to decipher from the acknowledgements sent by the data logger that the data it sent had been sent in a timely and robust manner, and thus should be able to reduce the transmit power level until the acknowledgements are no longer received in such a manner, at which stage the sensory device can increase the transmission power to a threshold level suitable ((Pmax−x)+y) to allow effective communications from the sensory device to the data logger, whilst also allowing a suitable buffer level of available power.

The sampling rate of the data should also be selected by the sensory device in a dynamic fashion. The data that the sensory device produces can be acquired at a range of varying rates, determined by the user of the device, pre-programmed into the sensory device or configured remotely. If the sensory device collects sensory data at a sampling interval (Ts) of 0.1 s, the sensory device has the option of routing the sampled data to the datalogger at the same rate, assuming the connection exists and the bandwidth (Bd) downstream of the data logger is sufficient, or, the sensory device may buffer the data for a period of time (Tb) and then send the buffered data in one stream.

The criticality of the data from the sensory devices attached to the datalogger may be determined by the system administrator. In reality in a human physiological monitoring exercise, the data coming from a wirelessly attached ECG may be the most important type of data, followed by data from an SpO2 monitor, followed by data from a blood glucose monitor. The criticality of the attached sensory devices, can therefore be indicated by their criticality factor (Cf). With the criticality factor starting at 1 (Cf1) for essential devices, then decreasing to Cf2 for the next most critical devices etc.

Assuming the Bandwidth Bd is a finite value at any point in time, it is therefore possible to route sensory device data according to its criticality and sampling rate. Thus the bandwidth Bd may be proportioned with the correct scaling factor to allow the most critical sensory devices the ability to route their data at the desired sampling rate Ts, with the minimal amount of sampled data being routed to the sensory devices storage buffer Tb. Thus when the bandwidth Bd is high enough to support a high sampling rate Ts, there will be a low usage of the buffer store Tb; thus Bd supports Ts, with Ts being inversely proportional to Tb.

If the bandwidth Bd is high enough to support two equally high critical factor CF1 Sensory devices (Dev1 and Dev2) then equal bandwidth Bd/2 will be applied to either device Dev1 or Dev2, however if the bandwidth B is only 50% of the Bandwidth required (Bdreq) to support both Dev1 and Dev2, then Dev1 and Dev2 can utilise their buffers and send when the bandwidth becomes available. With Dev1 taking all of the Bandwidth (BdDev1) first, then Dev2 consuming all the available bandwidth (BdDev2). It is assumed in this scenario that a hashing function, compression, and or encryption will also be used to reduce the data throughput to prevent an exponential growth in the data stored to data being sent ratio.

The encryption may be performed using any suitable encryption algorithm. The mechanism by which encryption at the datalogger is performed can be dependent on factors including the level of energy stored by the datalogger. For example, the datalogger may store an energy threshold. When the energy stored by the datalogger (e.g. the level of charge remaining in its battery) exceeds the threshold data received by the datalogger from the sensor devices is encrypted by the datalogger by means of a first algorithm and then transmitted to the server. When the energy stored by the datalogger is less than the threshold data received by the datalogger from the sensor devices is encrypted by the datalogger by means of a second algorithm and then transmitted to the server. The second algorithm is an algorithm the implementation of which by the datalogger uses less energy than the first algorithm, for example, the first algorithm could use a longer encryption key than the second algorithm. Alternatively, when stored energy is below the threshold the datalogger could omit to encrypt data before sending it to the server. These mechanisms have the advantage of prolonging the operational time of the datalogger whilst maintaining full operational performance when energy is readily available. In this way, the device can avoid the loss or delay of critical data when energy would otherwise run out.

This switching between devices may be performed in any suitable manner. One example is to use the round robin principles of data switching between devices, analogous to a Bluetooth piconet.

If the datalogger is equipped with multiple wireless interface modules that support the same protocol, then it would be possible to create different sub groups of protocol similar devices according to the criticality factor of the attached devices, thus allowing the processing of the datalogger to be configured to place the most cycles and processing threads to assign and manage the high Cf devices, whilst still allowing some threads and processing cycles for the low Cf devices, with a scaling proportionality appointed as to the number of high and low criticality devices.

In cases where the sensory devices attached to the datalogger are of different criticalities and protocols, the data logger can appoint resources proportionally. If Dev1 is an ANT protocol device and of Cf1 and Dev2 a Bluetooth device of Cf2, these devices will utilise different amounts of TX power and appear with different strengths in the same frequency bands. The datalogger may advantageously be dynamic enough to be able to calculate and manage the criticality of the devices in the context of the protocols which are routing the sensory devices' information. In some cases it may be necessary to limit or truncate one protocol's efficacy, in order to route or receive packets of a higher criticality from another protocol. In such cases the device which has its transmission protocol interrupted can advantageously revert to capturing their sensory data to local memory when it is not transmitting.

The datalogger can advantageously be able to receive near live time series data from a range of wired and wireless attached sensory devices. Owing to wireless data transmission constraints the datalogger can advantageously be able to control and apportion the available bandwidth located to facilitate a proportion of the available bandwidth such that live information may be sent across the wireless link, as well as historical data that has been buffered and stored by the sensory device in its memory.

This balance between live and post live data bandwidth is known as the Bandwidth Timeliness Function (Bd-tf). It is envisaged that this scenario would allow for interruptions to the sensory devices' available uplink bandwidth. The Bandwidth Bd can be sub divided into bandwidth for near live data (Bd-nl) and bandwidth for post live data (Bd-pl), with the sub division being dynamically controlled by data logger. In such a manner the datalogger can control the availability of both the live and post live data. It is preferable that for sensory devices with high criticalities that the Bandwidth Timeliness Function will favour 100% near live data (Bnl) until there is a break in the reception of the time series data from the sensory device that the near live proportion of the Bandwidth Timeliness Function will far exceed that of the post live proportion. When a break in the reception of the data is realised then the datalogger will adjust the Bandwidth time function (Bd-tf) to allow part of the available bandwidth to be proportioned to received the post live data (Bd-pl) when communications are re-established or adjust the available bandwidth (Bd) accordingly.

### Upload of Data

The data logger can advantageously also be able to control and allocate dynamically enough processing and transmission resources to handle the various protocols, bearing in mind that the transmission protocols to pass the data upstream utilising Bandwidth (Bu) to a server may well interrupt the transmission of the data from the sensory devices into the datalogger and vice versa thus reducing bandwidth both upstream (Bu) and downstream (Bd).

As such there will be a trade off between processing the received data from the sensory devices, and sending the received data upstream. The datalogger can advantageously maintain the optimum balance of receive and forwarded processing power, this optimum balance being known as the Marshalling function (M)

The datalogger adopts a strategy that is programmed into its firmware for uploading the logged data to the server infrastructure. That strategy preferably favours methods of communication that use less power, for example communication over a wireless LAN connection rather than over a mobile phone connection. The interval between transmissions may depend on the availability of a low-power connection. However, the interval is preferably also capable of being altered in two ways under command from the server infrastructure.

The server infrastructure can instruct the datalogger to transmit data more promptly (preferably immediately if bandwidth Bu/Bd permit and this does not effect the criticality of the other sensory devices) when the datalogger detects that the sensory device data meets a certain value based threshold. In such a manner the datalogger can be programmed to monitor and react to the physiological changes of the sensory device network attached to the subject.

This allows the datalogger to alert a user of the server infrastructure immediately if the subject of the datalogger meets a certain physiological condition. That condition could, for example, be that the subject's blood pressure is greater than a set value or that the subject's pulse rate is below a set value.

Alternately, a user of the server infrastructure can instruct the datalogger to transmit data more or less frequently irrespective of the content of the sensed data if the user of the datalogger is to be monitored more or less intensively. The intensity of monitoring may depend on clinical decisions made by the user of the server, or this process may be automated through reporting server 98.

The server transmits to the datalogger acknowledgements for data that it receives. When the datalogger has successfully uploaded data to the server infrastructure it deletes that data from its memory. In the same manner as the Bandwidth Timeliness Function (Bd-tf) operates for the bandwidth between the sensory devices and the datalogger, a similar Bandwidth Timeliness Function (Bu-tf) operates for the upstream bandwidth. It is envisaged that this scenario would allow for interruptions to the datalogger's available uplink bandwidth. The Bandwidth Bu can be sub divided into bandwidth for near live data (Bu-nl) and bandwidth for post live data (Bu-pl), with the sub division being dynamically controlled by server. For instances where the processing power is limited on the datalogger, and so as not to overload the datalogger's processor, a further scalable downlink bandwidth is defined for communications from the server back downstream to the datalogger. This bandwidth is defined as (Bu-dl) and is defined to allow the server to control the processor's upstream sending function, such that new firmware, software, memory images, or instructions may be sent to the device in the timeliest manner.

In such a manner the datalogger can control the availability of both the live and post live data. It is presumed that until there is a break in the reception of the time series data from the datalogger that the near live proportion of the Bandwidth timeliness function will far exceed that of the post live proportion. When a break in the reception of the data is realised then the datalogger will adjust the Bandwidth time function (Bu-tf) to allow part of the available bandwidth to be proportioned to received the post live data (Bu-pl) when communications are re-established or adjust the available bandwidth (Bu) accordingly.

If the datalogger detects that the sensory devices data is out of pre defined limits, the processor acting within the datalogger can dynamically increase or decrease the criticality level (Cf) of the sensory device accordingly, whilst simultaneously increasing or decreasing both the time sampling rate (Ts) or buffering (Tb) accordingly. This would be done such that the datalogger might have enough autonomy to adapt to human physiological condition changes as detected by the attached sensory devices.

In a similar manner, the datalogger has the ability to adapt the Bandwidth timeliness functions Bu-tf and Bd-tf upon analysis such that the emphasis should be placed on live data coming through at any cost. This scenario is described to account for a specific physiological action or reaction being caught by the datalogger, and the systems pre determined action is to enable as much live data to be sent, with post live data being discarded. The latest live data coming through being more important than the bandwidth being throttled by post live data trying to fill in the gaps.

Likewise if the server detects that the sensory devices' data is out of pre defined limits, the server can dynamically increase or decrease the criticality level (Cf) of the sensory device accordingly by relaying this to the datalogger, whilst simultaneously increasing or decreasing both the time sampling rate (Ts) or buffering (Tb) accordingly. This would be done such that the server might have enough autonomy to adapt to human physiological condition changes as detected by the attached sensory devices.

Once again, the server has the ability to adapt the Bandwidth timeliness functions Bu-tf and Bd-tf in dependence upon analysis such that the emphasis should be placed on live data coming through at any cost. This scenario is described to account for a specific physiological action or reaction being caught by the server, and the systems pre determined action is to enable as much live data to be sent, with post live data being discarded. The latest live data coming through being more important than the bandwidth being throttled by post live data trying to fill in the gaps

### Analysis or Review of Data

The server infrastructure holds the logged data for each subject whose data has been collated via a datalogger. Data stored at the server infrastructure can then be accessed by third parties. The third parties are then able to analyse each subject's data. Consequently, the third parties can advise each subject on the correct course of action. The data remaining on the server for aggregated research purposes.

The reporting server 98 is pre-programmed with analysis routines which it runs on the data from selected subjects that are stored within database 97. The analysis routines may be designed to detect features of the subjects' data, and on the detection of such features, raise certain flags. As an example, the analysis routines may analyse some or all of the subjects' ECG data to detect features indicative of problematic cardiac function. If such a feature is detected in a subject's data then an alert may be triggered automatically. The alert may be made in a number of ways. It could be sent as a message to a person who is designated as working with that user. Alternately a message could be passed to the subjects' datalogger in a manner that might trigger the datalogger to display a massage to the user. Alternatively it could be sent to the datalogger or other communication terminal (e.g. a mobile phone) of another individual who is designated as working with the subject. Alerts to network connected staff can be made through the interfaces 100 or 101. Alerts to the subject or to another individual may be made through the networks 91 or 93.

It is assumed that the subject data is anonymous within the system. The system merely needs to know a subject reference number to attach the data coming from the datalogger into the system. In such a manner the system is able to perform automated comparative analysis between a subject and the whole system, based on parameters identified as interesting comparators identified by a user of the system. The system may present its stored human physiological data to other such systems to provide extended search and comparison analysis, these could include searching against other systems that hold previous data acquired from a specific subject such as a patient record etc.

### Configuration of the Datalogger

The datalogger stores firmware 11 in non-volatile memory 4. The firmware may be made up of program code that is executable by the processor 3 and meta-code, such as configuration files or image files that store parameters, images or layout definitions that can be used by the processor during execution. The firmware of the sensor modules is composed in a similar way.

The configuration database 103 stores data indicating the configuration of each of the dataloggers in the system and their currently associated sensory devices. That includes, for example, the software version and the configuration files that are meant to be on each datalogger.

The firmware of each datalogger can be updated from the server infrastructure. This is done by the server infrastructure sending replacement firmware to the datalogger together with an instruction for the datalogger to install and use the new firmware. The datalogger may need to reboot itself after installing the new firmware. In a similar way, the server infrastructure can also send the datalogger new firmware that it is to transmit to the sensor modules for installation on them. This mechanism of updating the firmware requires no intervention from the user of the datalogger, making it easier for the datalogger to be used by people with less technical skills.

The firmware may configure functions such as the criticality factor (Cf) of each associated sensory device, coupled with the sampling interval (Ts) of each sensory device, the starting Bandwidth Timeliness Function (Bd-tf) for the sensory device to datalogger relationship, as well as the starting Bandwidth Timeliness Function (Bu-tf) for the datalogger to server relationship. From a higher level perspective the firmware may identify the type of the sensory device as well as any unique identifier of the device such as to form a logical association with the specific sensory device and the specific datalogger. The firmware will also control the user interface of the datalogger and human inputted data gathering functions of the datalogger. In such a manner the server algorithms may decide how the sensory device data may be changed dynamically and in real time to reflect the physiological data coming into the server.

An operative of the system may decide that the user needs to be issued with a new type of sensor module. The sensor module can be sent to the user, and meanwhile firmware code that allows the datalogger to communicate with and make use of the data from such a sensor module can be downloaded to the datalogger. The datalogger might be locked so that it will only communicate with sensory devices having a certain identity, a certain type, or a certain unique identifier, such as a MAC address. In such a scenario the identity of the new sensor module is also downloaded to the datalogger. If the datalogger is reported as being lost, then the server infrastructure could send a signal of a predetermined format in response to which the datalogger will erase all sensory devices association with that datalogger.

The datalogger has a display that can provide information to the user. The display may be configured by firmware. If the display is touch-sensitive then one significant aspect of the configurability of the display is that the size and layout of elements of the user interface presented by the display can be customised for particular users.

In the case of a touch-sensitive display the buttons are represented by displayed areas of a distinctive appearance. The processor is configured to respond to pressure on the display anywhere in one of those areas to perform a function related to the information displayed in that area. The user interface can be reconfigured through firmware to alter the size of the regions that are responsive to pressure in that way, and the corresponding displayed zones, effectively changing the size of the buttons on the touch screen. The user interface could be customisable in other ways. For example, the language of any text on the display could be configured by firmware.

The datalogger could display alerts that are received from the server infrastructure. In response to receiving the message the datalogger automatically displays the alert contained in the message. That alert could, for example, be a reminder to take certain medication or to make a certain measurement. The alert could be a reminder to a third party in a similar manner to ensure the subject has undertaken said action. The server may be configurable to send such alerts automatically.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1-28. (canceled)

29. A data logging system comprising a datalogger and a plurality of sensor devices, the datalogger comprising a configurable memory storing a plurality of priorities, each associated with a respective one of the sensor devices, the datalogger being configured to cause data from the sensor devices to be processed in accordance with the stored priorities such that the transmission of data to the datalogger from a sensor device associated with a relatively high priority is prioritised over the transmission of data to the datalogger from a sensor device associated with a lower priority.

30. A data logging system as claimed in claim 29, wherein the datalogger is configured to store sensed data received from the sensor devices in accordance with the stored priorities such that the storage of data from a sensor device associated with a relatively high priority is prioritised over the storage of data from a sensor device associated with a lower priority.

31. A data logging system as claimed in claim 29, wherein the datalogger is configured to compress and/or encrypt sensed data received from the sensor devices in accordance with the stored priorities such that the compression and/or encryption of data from a sensor device associated with a relatively high priority is prioritised over the compression of data from a sensor device associated with a lower priority.

32. A data logging system as claimed in claim 29, wherein the system comprises a server remote from the datalogger, and the datalogger is configured to transmit to the server data received from the sensor devices in accordance with the stored priorities such that the transmission to the server of data from a sensor device associated with a relatively high priority is prioritised over the transmission to the server of data from a sensor device associated with a lower priority.

33. A data logging system as claimed in claim 29, wherein the sensor devices are capable of sampling data and buffering sampled data and the datalogger is configured for adaptively and/or dynamically controlling the manner in which each of the sensor devices samples and/or buffers data in dependence on the priority associated with the respective sensor device.

34. A data logging system as claimed in claim 29, wherein the datalogger comprises one or more wireless communication interfaces for communicating over one or more wireless channels with the sensor devices and the datalogger is configured for dynamically allocating bandwidth of the wireless channel(s) for use by each sensor device so as to favour the delivery to the datalogger of data from a sensor device associated with a relatively high priority.

35. A data logging system as claimed in claim 33, wherein the datalogger is configured to allocate the bandwidth of the wireless channel(s) such that the amount of (B-nl) live near real time data is proportioned against the data transfer of (B-pl) post real-time data, such that a continued delivery of data is achieved, and a fully populated time record of the data is available at the end of the process, but not to the detriment of timely critical data.

36. A data logging system as claimed in claim 29, wherein the datalogger comprises one or more wireless communication interfaces for communicating over one or more wireless channels with the sensor devices and the datalogger is configured for dynamically allocating bandwidth of the wireless channel(s) for use by each sensor device so as to inhibit the sensor devices from transmitting sensed data to the datalogger faster than the datalogger can process the sensed data.

37. A data logging system as claimed in claim 29, wherein the system comprises a server remote from the datalogger, and the datalogger is configured to transmit data to the server in accordance with a power-management strategy in accordance with which the datalogger stores a maximum EIRP (Pmax) and is configured to reduce the power level of its transmissions to the server from this PMax level by a pre-set amount upon receipt from the server of a data transfer acknowledgement packet; and alternatively to increase the power level of its transmissions if no data acknowledgement packet is received within a pre-set time.

38. A system as claimed in claim 29, wherein the datalogger comprises one or more wireless communication interfaces for communicating over one or more wireless channels with the sensor devices and the datalogger is configured for allocating bandwidth of the wireless channel(s) for use by each sensor device so as to effectively manage the bandwidth allocated to each sensor device.

39. A data logging system as claimed in claim 29 wherein the datalogger comprises two or more wireless communication interfaces for communicating over two or more wireless channels with the sensor devices and the datalogger is configured to manage the usage of those channels by the sensor devices by one or more of associative bandwidth sharing, isolation, soloing and effective communications management.

40. A data logging system as claimed in claim 38, wherein the datalogger is configured to manage the bandwidth usage by the sensor device by means of a strategy that restricts interference due to communications by the sensor devices with the efficient operation of one or both of the data processing stack of the datalogger and the session layer of each wireless communication interface.

41. A data logging system as claimed in claim 29, wherein the system comprises a server remote from the datalogger, and the datalogger comprises one or more wireless communication interfaces for communicating over one or more wireless channels with the server, and the datalogger is configured to control the delivery of data from the datalogger to the server by means of the plurality of wireless communication interfaces in accordance with a pre-defined prioritisation so as to favour communication with the server over the highest prioritised interface that is currently capable of effective communication with the server.

42. A data logging system as claimed in claim 40, wherein the stored priorities can be changed dynamically such that the server can control the criticality and sampling rate of the sensor devices, based on a threshold of specific incoming data being reached.

43. A data logging system as claimed in claim 29, wherein the datalogger is capable of storing for each sensor device a data set comprising a definition of a device-specific identifier for that sensor device, a priority for that sensor device, an expected sampling rate (Ts) for that sensor device, a buffer rate (Tb) for that sensor device, a wireless or wired protocol specification for communication between the datalogger and that device, and wherein the datalogger is configured to control the transmission of sensed data from each sensor device to the datalogger in accordance with the data set stored for that sensor device.

44. A data logging system as claimed in claim 29, wherein the system comprises a server remote from the datalogger, and wherein the server is configured to allocate bandwidth over a channel between the server and the datalogger so as to allocate bandwidth for the timely download of new firmware to the datalogger.

45. A data logging system as claimed in claim 29, wherein the system comprises a plurality of dataloggers and a server remote from the dataloggers, the server being configured to analyse data received from the dataloggers and analyse the received data in accordance with a pre-defined set of rules.

46. A data logging system as claimed in claim 29, wherein the system comprises a server remote from the datalogger, the server being configured to transmit data to the datalogger to configure one or more of the sampling rate (Ts), buffer rate (Tb) or priority (Cf) of one or more of the sensor devices associated with that datalogger.

47. A data logging system as claimed in claim 29, wherein the datalogger stores a set of pre-defined rules and the datalogger is configured to analyse received data from one or more of the sensor devices in accordance with the rules.

48. A data logging system as claimed in claim 47, wherein the datalogger is configured to manage one or more of the sampling rate (Ts), buffer rate (Tb) or priority (CO of one or more of the sensor device in accordance with the rules.

49. A data logging system as claimed in claim 29, wherein the datalogger is configured to transmit a report to a remote recipient in response to the installation of new firmware on the datalogger.

50. A data logging system as claimed in claim 29, wherein the datalogger is configured to transmit a report to a remote recipient in response to the configuration by the server of one or more of the sampling rate (Ts), buffer rate (Tb) or priority (CO of one or more of the sensor devices associated with that datalogger.

51. A data logging system as claimed in claim 29, wherein the system comprises a server remote from the datalogger, and the datalogger is configurable by the server for communication with an additional sensor device by the receipt from the server of data defining one or more of the type, supported communication protocol(s), priority (Cf), sample rate (Ts) and buffer rate (Tb) of the sensor device.

52. A data logging system as claimed in claim 29, wherein the system comprises a server remote from the datalogger, the datalogger implements a graphical user interface and the datalogger is configurable by the server for re-configuration of the graphical user interface.

53. A data logging system as claimed in claim 52, wherein the re-configuration of the graphical user interface is responsive to a server-side push, or a client-side pull if a pre-defined rule dependent on data received from one or more the plurality of sensor devices is excepted.

54. A data logging system as claimed in claim 29, wherein the system comprises a server remote from the datalogger, and the datalogger is capable of storing a diary of events, the events being programmable by the server, and the datalogger being capable of presenting messages to alert a user to an event.

55. A data logging system as claimed in claim 54, wherein the datalogger is capable of monitoring the user's compliance with the diary of events and is configured to transmit to the server data indicating the user's compliance to the server.
